(19) United States
(12) Patent Application Publication
(10) Pub. No.: US 2012/0148970 A1
(43) Pub. Date: Jun. 14, 2012

(54) Cushion Comfort Cushion System for use with Orthodontic Protraction Face Masks: The Naomi Pillow

(76) Inventor: Karen Kassap, Woodbridge, CT (US)

(21) Appl. No.: 12/963,249

(22) Filed: Dec. 8, 2010

(51) Int. Cl. A61C 7/06

(52) U.S. Cl. 433/5

(57) ABSTRACT

A Cushion Comfort System which improves the comfort and use of an orthodontic protraction face mask appliance. It is comprised of a pair of cushions, one shaped specifically to cover the forehead rest and the other shaped specifically to cover the chin cup. The forehead cushion and chin cup cushion may be used individually for face masks that have only a forehead rest or only a chin cup. The cushions are made of soft, hypoallergenic, colorful fabrics, soft hypoallergenic pillow fill or batting, and elastic ribbons. They are completely removable and washable. Other embodiments are described.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

This invention generally relates to extraoral orthodontic appliances, specifically to an improved cushion system for the forehead rest and the chin cup of the protraction face mask

2. Prior Art

There are several types of extraoral appliances used in contemporary orthodonture. Protraction face mask therapy is most effective in patients who are 10 years of age or younger since they are still growing. These devices can be connected to brackets or other hardware on the patient's teeth, usually with elastic bands, they then apply pressure to the patient's forehead and chin. Several styles of the protraction face mask exist and each claims to provide greater compliance of usage due to its particular design and the flexibility of the forehead and chin segments. Among the relevant protraction face masks there are Multi Just™ Adjustable Face Mask sold by Orthodirect (2010 Orthodontic Reference Guide, p.65) and those sold by Great Lakes Orthodontics, (Catalogue pp 60-63,65) namely: Adaptable Class III Mask, Reverse-Pull Face Cribs, Hickham Headgear and Keles Face Mask. None of these fully address the issue of discomfort that arises from the pressure of the forehead rest and chin cup. These devices are manufactured with adhesive backed thin foam coverings for the forehead rest and chin cup to ease the irritation and discomfort that results from wearing the apparatus. This padding is quickly worn down and frequently falls off due to body heat and moisture from perspiration. The edges of the forehead rest and chin cup are hard and press into delicate skin leaving marks, especially when the patient is sleeping and leans on the appliance.

U.S. Pat. No. 5,205,735 discloses a headgear pillow which is used successfully with orthodontic/facial orthopedic appliance U.S. Pat. No. 4,988,291 to protect the patient's cheekbones. This deals with similar issues of discomfort and pressure on the face from an orthodontic appliance but it does not address a forehead rest or a chin cup. There are other extraoral orthodontic devices such as the Reverse Pull Face Crib which is produced with adhesive backed foam pads, and the Adaptable Class III Mask designed by Henri Petit which is sold with a silopad®. The adhesive backed foam pads do not amply cover the edges of the forehead rest and chin cup. Also perspiration and saliva cause foam pads to become malodorous and causes their adhesive properties to deteriorate. The silopad® cushion is used in the same manner as the adhesive backed foam pads and can also be uncomfortable since its composite material encourages perspiration and does not allow air flow to the skin.

Successful treatment with extraoral orthodontic devices is directly related to compliance with their usage. Since the vast majority of patients treated with these devices are young children, comfort is critical to the child's commitment to the treatment plan. In addition, the attractiveness of the materials used in making the comfort cushions will also enhance the patient compliance.

### SUMMARY

In accordance with one embodiment a cushion system for use with extraoral orthodontic protraction facemasks comprises a pair of cloth cushions adapted to fit one on the forehead rest and one on chin cup of said appliance

### DRAWINGS

### Figures

In the drawings, closely related parts have the same number but different alphabetic suffixes.

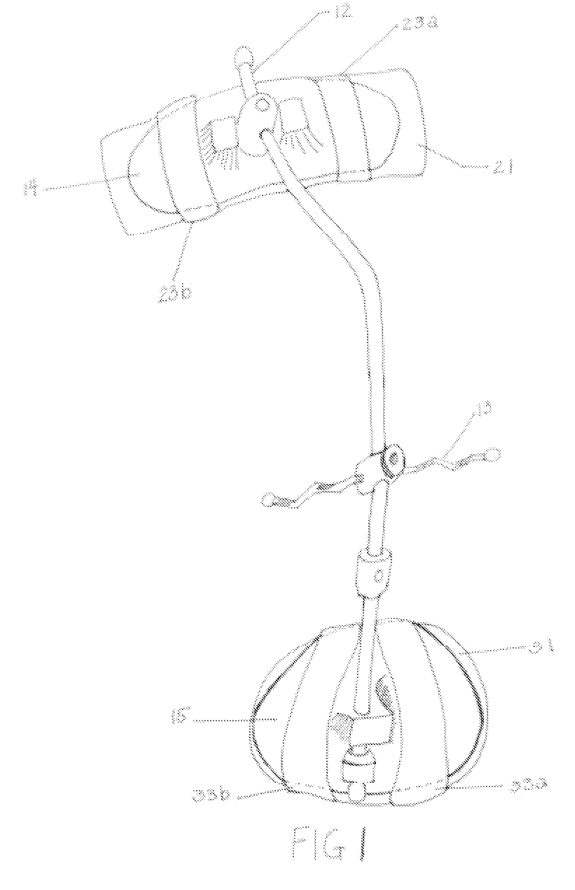

FIG. 1 shows a frontal view of the cushion comfort system attached to an orthodontic protraction face mask.

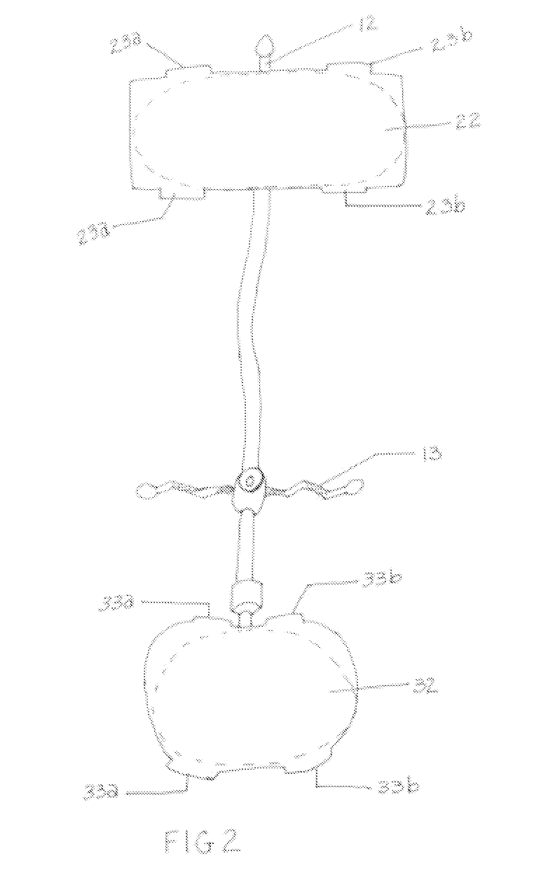

FIG. 2 shows an interior side view of the cushion comfort system attached to an orthodontic protraction face mask.

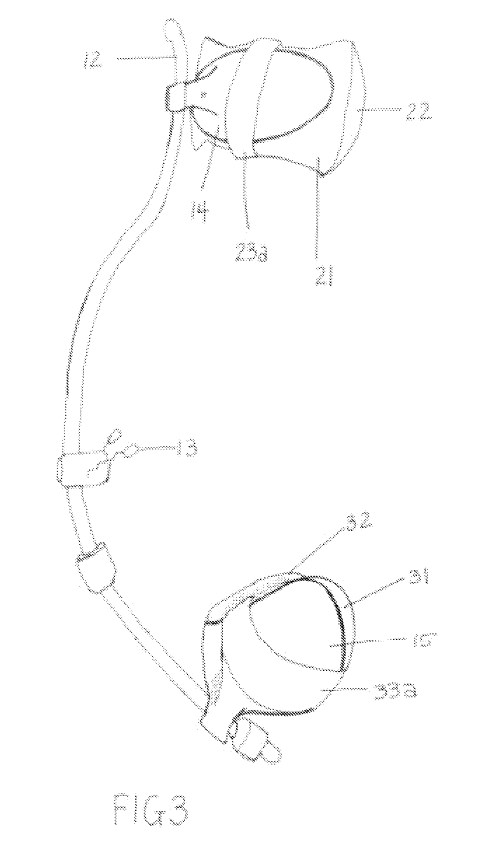

FIG. 3 shows a side view of cushion comfort system attached to an orthodontic protraction face mask.

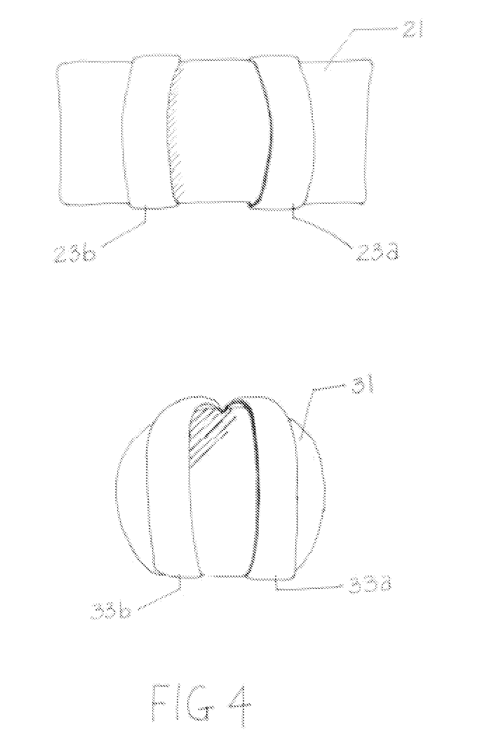

FIG. 4 shows frontal view of both the forehead rest cushion and the chin cup cushion of the cushion comfort system independent of the orthodontic protraction face mask.

### REFERENCE NUMERALS

12 vertical bar of protraction face mask

13 horizontal bar of protraction face mask, attachment connecting elastic bands

14 forehead rest of protraction face mask

15 chin cup of protraction face mask

21 forehead cushion frontal view

22 forehead cushion interior view

23a forehead cushion right side attachment device

23b forehead cushion left side attachment device

31 chin cup cushion frontal view

32 chin cup cushion interior side

33a chin cup right side cushion attachment device

33b chin cup left side cushion attachment device

### DETAILED DESCRIPTION

### First Embodiment

### FIGS. 1, 2, 3, 4

One embodiment of the cushion comfort system is shown in FIG. 4 which illustrates a frontal view of a cushion (21) shaped to accommodate a forehead rest of an orthodontic protraction face mask with attachment devices (23a, 23b), and a frontal view of a companion cushion shaped to accommodate a chin cup on the orthodontic protraction face mask with attachment devices (33a, 33b). FIG. 1 (frontal view) and FIG. 2 (interior view) and FIG. 3 (side view) illustrate the manner in which the cushion system may be attached to the orthodontic appliance. The cushion comfort system is designed to work primarily with a protraction face mask such as the Multi Just™ Adjustable Face Mask and the Class III Mask designed by Henri Petit, but may work with any similarly designed apparatus, including protraction headgear with only a chin cup or only a forehead rest. The dimensions of the cushions may easily be adjusted to cover varieties of size and shape of the forehead rest and chin cup parts by one skilled in the art.

In the preferred embodiment the cushions are made of 100% colorfast cotton cloth, but any soft non-allergenic and washable fabric may be used. The cushions are filled with hypoallergenic synthetic polyfiber fill, but any soft pillow fiber fill may be used, including but not limited to, shredded fabric remnants or cotton batting. The cushions are loosely filled to about ¾″ thickness.

Both cushions have a front side (21, 31 (FIGS. 1, 4)) and an interior side (22, 32 (FIGS. 2, 3)). The interior side faces the patient's forehead and chin. The front sides are in contact with the forehead rest and chin cup and their attachment device is located here as well. The preferred embodiment of the attachment device is ⅝″ elastic ribbon, but other attachment mechanisms may be devised including but not limited to hook and loop fasteners, and cloth loops. In the preferred embodiment of the attachment device for the forehead cushion, the elastic ribbons (23a, 23b (FIGS. 1, 4)) are placed parallel to each other and approximately ¾″ from the vertical edges of the pillows. In other embodiments the placement of the attachment device for the forehead rest may be varied according to the manufacturer's developments in the shape of the forehead rest as well as the nature of the attachment material. In the preferred embodiment of the attachment device for the chin cup cushion, the elastic ribbons (33a, 33b (FIGS. 1, 4)) are placed in an inverted “vee” shape with two straps placed closely together at the top, rounded, side of the cushion. At the flatter, bottom side, of the cushion, the elastic ribbons are placed approximately ¼″ from the center or ½″ apart from each other. In other embodiments the placement of the attachment device for the chin cup may be varied according to developments in the shape of the chin cup as well as the nature of the attachment material.

### Operation

### First Embodiment

The manner of using the cushion comfort system requires attaching the cushions to the forehead rest and the chin cup rest of the protraction face mask orthodontic device. The cushion comfort system will provide protection and comfort for the child's forehead and chin while they wear their protraction face mask orthodontic device. The inside of the forehead cushion (22 (FIGS. 2, 3)) will rest against the child's forehead; in between the forehead rest and the child's forehead. The inside of the chin cup cushion (32 (FIGS. 2, 3)) will rest against the child's chin; in between the chin cup and the child's chin.

The front of the forehead cushion (21 (FIGS. 1, 3, 4)) is attached to the forehead rest by slipping either the left or right side of the rest under the corresponding attachment device and then slipping the opposite side of the forehead rest under its corresponding attachment device. For example the left side of the forehead rest (14 (FIG. 1)) would be slipped under the cushion's left attachment device (23b (FIG. 1)) and then the right side of the forehead rest (14 (FIG. 1)) would be slipped under the cushion's right attachment device (23a (FIGS. 1, 4.))

The front of the chin cup cushion (31 (FIGS. 1, 4)) is attached to the chin cup (15 (FIG. 1)) by slipping either the left or right side of the rest under the corresponding attachment device and then slipping the opposite side of the chin cup rest under its corresponding attachment device. For example the left side of the chin cup rest (15 (FIGS. 1, 3)) would be slipped under the cushion's left attachment device (33b (FIGS. 1, 4)) and then the right side of the chin cup (15 (FIGS. 1,3)) would be slipped under the cushion's right attachment device (33a (FIGS. 1,4)). I presently contemplate that the chin cup cushion fits best when attached with the point of the “vee” facing toward the forehead. However, it can be attached in an alternate position to suit the comfort of the user, or other shapes of chin cup or to accommodate other materials used to make the attachment device.

The cushions are removed in the same manner in which they were attached; one side at a time. I presently contemplate that the cushions are made of entirely washable materials, and they may be easily removed and cleaned when necessary.

### Additional Embodiments

There are various possibilities with regard to the shapes of the comfort cushion system. FIGS. 1, 2, 3 illustrate a rectangular cushion paired with a truncated oval cushion. These are shaped to cover the forehead rest and chin cup rest of the Multi Just™ Adjustable Face Mask orthodontic device. There are other versions of the protraction face mask and the shape of their forehead rests and chin cups vary slightly from the present examples. However, the shape of the cushions may easily be altered by one skilled in the art to accommodate these new shapes as well as any innovations in the orthodontic appliance.

Additionally, there are various possibilities with regard to the method of attachment of the cushion comfort system. Elastic ribbons are simple to use, however, cloth straps, and adhesive backed hook and loop closures could also be used successfully. The shape of the extraoral face mask appliance is also determinative of the placement of the attachment devices. However, adjustments may be easily made by one skilled in the art to accommodate varieties in shape and size.

### Conclusions, Ramifications and Scope

Thus the reader will see that the various embodiments of the cushion comfort system can be used to make the wearing of protraction face mask appliances comfortable and inviting, and consequently improve patient compliance and improve medical results. The protraction face mask appliance is almost exclusively used in treating young children and its appearance can be intimidating for young children. Use of colorful and attractive printed fabrics for the cushion system lowers the level of anxiety in the patients. Additionally, the marked increase in comfort which results from a soft cushion protecting the tender skin on a child's forehead and chin will also improve their compliance with and the successful use of the protraction facemask appliance. While the above description contains many specificities, these should not be construed as limitations on the scope of any embodiment, but as exemplifications of the presently preferred embodiments thereof. Many other ramifications and variations are possible within these various embodiments. For example: the shapes of the cushions; the color, pattern and composition of the fabrics used in the manufacture of the cushions; the materials used in stuffing the cushions and the methods of attachment. For some types of protraction face masks only one of the two cushions may be necessary.

Thus, the scope of the invention should be determined by the appended claims and their legal equivalents, and not by the examples given.

I claim:

1. Cushion Comfort System for use with orthodontic protraction face masks comprising:
(a) paired cloth cushions, one rectangular for the forehead rest and one truncated oval for the chin cup of the dimensions of which are predetermined by the size of the said appliance,
(b) interior and exterior sides to each cushion,
(d) means of securing the cushions to forehead rest and chin cup located on exterior side.

2. The Cushion Comfort System of claim 1 wherein said means to secure cloth cushions to orthodontic protraction face masks is with elastic straps through which the appliance slides.

3. The Cushion Comfort System attachment of claim 2 is formed by two parallel elastic straps on the rectangular forehead cushion.

4. The Cushion Comfort System attachment of claim 2 is formed by two elastic straps that form a “vee” shape on the truncated oval chin cup cushion.
